(19) United States
(12) Patent Application Publication
(10) Pub. No.: US 2007/0094280 A1
(43) Pub. Date: Apr. 26, 2007

(54) Mobile communication terminal

(76) Inventors: Elina Vartiainen, Helsinkii (FI); Salla Myllyla, Helsinki (FI); Virpi Roto, Espoo (FI); Andrei Popescu, Helsinki (FI); Mika Rautava, Espoo (FI); Guido Grassel, Espoo (FI)

Correspondence Address: PERMAN & GREEN, 425 POST ROAD, FAIRFIELD, CT, 06824, US

(21) Appl. No.: 11/259,623

(22) Filed: Oct. 26, 2005

(51) Int. Cl. G06F 7/00

(52) U.S. Cl. 707/100

(57) ABSTRACT

It is presented a method for saving data shown on a display of a mobile terminal, comprising the steps of: receiving an input indicating that currently shown data is to be saved; determining save data, the save data comprising a part of a document shown on the display; and saving the save data in a user-accessible memory. A corresponding apparatus and computer program is also presented.

### FIELD OF THE INVENTION

The present invention generally relates to mobile terminals and more particularly to saving data shown on the display of a mobile terminal.

### BACKGROUND OF THE INVENTION

Mobile terminals, or mobile (cellular) telephones, for mobile telecommunications systems like GSM, UMTS, D-AMPS and CDMA2000 have been used for many years now. In the older days, mobile terminals were used almost only for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, electronic games, calendar/organizer/time planner, word processing, etc.

Using web browsers in mobile terminals presents users with a particular problem. A user may find information in a web document, for instance an address or a map, that the user wishes to save to be accessed easily at a later point in time.

One alternative for the user to save the information is to save the currently viewed document as a bookmark, allowing the user to navigate back to the document to view the desired information. However, the position of the desired information in the document is not saved, resulting in the user having to perform a tedious scroll to the correct position to view the desired information. Additionally, to view the desired information, the browser may need to access the web document from the server once again, leading to a frustrating time delay.

Another alternative is, similar to what a user might do to perform a similar task in a computer, for the user to select the desired data, copy that data into a temporary buffer, paste the data from the buffer to a document in some type of editor and save the document. A problem with this alternative is that it is cumbersome to select the desired information in the limited user interface provided in a mobile terminal. Another problem is the number of actions the user has to perform to save the desired data, resulting in a procedure which is not very user friendly.

Consequently, there is a need to provide a convenient and efficient way for a user to save data currently shown on a display of a mobile terminal.

### SUMMARY OF THE INVENTION

In view of the above, an objective of the invention is to solve or at least reduce the problems discussed above.

Generally, the above objectives are achieved by the attached independent patent claims.

According to a first aspect of the invention there has been provided a method for saving data shown on a display of a mobile terminal, comprising the steps of: receiving an input indicating that currently shown data is to be saved; determining save data, the save data comprising a part of a document shown on the display; and saving the save data in a user-accessible memory. This way, the user is provided with a way to save data which may have taken a substantial amount of time to get to, for easy retrieval at a later stage.

The part of the document may comprise data of the document shown on the display and data of the document located after data shown on the display. This allows a user to scroll down and view part of the document below where the screen view is located at the time of the save.

The step of saving the data may include saving at least one parameter indicating a position of a currently shown view in the document. Saving the position simplifies viewing of the document later.

The step of saving the save data may involve: saving a copy of the document; and saving at least one parameter indicating a position of a currently shown view in the document. In other words, when the user later retrieves the data, it will be presented in the same way that it is presented at the time of saving the data, including the position in the document. Moreover, the time to present the data is relatively small, as all data is stored locally in the mobile terminal.

The step of saving the save data may involve: saving a reference to a copy of the document, the copy being previously stored in the mobile terminal; and saving at least one parameter indicating a position of a currently shown view in the document. Sometimes, a copy of the document may already exist in a memory of the mobile terminal. If that is the case, it is unnecessary to create another copy; a reference to the existing copy is sufficient. This embodiment may have a reference counter on the document, such that every use of the document increases the counter and a dereference decreases the counter, whereby the document is erased when the counter reaches 0, i.e. no application needs the document anymore.

The document may be an original document, and the step of saving the save data may involve: creating a modified document being a modification of the original document, such that content items of the original document currently visible on the display are copied to produce the modified document; and saving the modified document in a user-accessible memory. In this way, the memory required to save the data is reduced, as the number of content items are reduced compared to a full copy.

The document may be rendered by a browser application. Additionally, the document may comply with a markup language selected from a group consisting of hypertext markup language, wireless markup language and extensible markup language. As finding particular information using a web browser may take quite some time, the invention is applicable for use with a web browser.

The save data may include text data and image data. Both these types of data are useful to save for later easy access.

The user-accessible memory may be a local non-volatile memory in the mobile terminal. Consequently, data is not lost if the mobile terminal is switched off or the battery runs out of power.

The method may comprise the further steps of: receiving an input indicating that the saved data is to be presented; retrieving the saved data from the user-accessible memory; and presenting the saved data on the display. This provides a way for the user to easily access and display the saved data.

A second aspect of the invention is a method for saving a reference to document currently rendered on a display of a mobile terminal by a browser application, comprising the steps of: receiving an input indicating that a reference to currently shown data is to be saved; saving, in a user-accessible memory, an identifier to the document and at least one parameter indicating a position of a currently shown view in the document. In this embodiment, a link is saved, whereby the actual text and binary data does not have to be saved, reducing the memory space required, while still providing the user with an easy way to display the data the way it is displayed.

A third aspect of the invention is a method for saving data shown on a display of a mobile terminal, the method comprising the steps of: receiving an input indicating that currently shown data is to be saved; saving an image copy of an entire document, at least part of the document currently being rendered on the display by a browser application; and saving at least one parameter indicating a position of a currently shown view in the document. Saving the data as image data allows fast rendering when the data is later displayed. Saving the entire document with positioning data also allows the user to, if desired, scroll through the document when it is presented.

The user-accessible memory may be a local non-volatile memory in the mobile terminal. Consequently, data is not lost if the mobile terminal is switched off or the battery runs out of power.

A fourth aspect of the invention is a mobile terminal capable of saving data shown on a display of the mobile terminal, the mobile terminal comprising: means for receiving an input indicating that currently shown data should be saved; means for determining data to be saved, the data comprising a part of a document shown on the display; and means for saving save the data in a user-accessible memory. This way, the user is provided with a way to save data which may have taken a substantial amount of time to get to, for easy retrieval at a later stage.

The data shown on the display may be rendered by a browser application. As finding particular information using a web browser may take quite some time, the invention is applicable for use with a web browser.

The document complies with a markup language selected from a group consisting of hypertext markup language, wireless markup language and extensible markup language.

A fifth aspect of the invention is a computer program comprising software instructions that, when executed in a mobile communication terminal, performs the method according to the first aspect of the invention. This way, the user is provided with a way to save data which may have taken a substantial amount of time to get to, for easy retrieval at a later stage.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be described in more detail, reference being made to the enclosed drawings, in which:

FIG. 1 is a schematic illustration of a cellular telecommunication system, as an example of an environment in which the present invention may be applied.

FIG. 2 is a schematic front view illustrating a mobile terminal according to an embodiment of the present invention.

FIG. 3 is a schematic block diagram representing an internal component, software and protocol structure of the mobile terminal shown in FIG. 2.

FIGS. 4A to 4E illustrate screenshots of a display of an embodiment of the present invention when saving current display data.

FIG. 5 is a flowchart diagram that illustrates the operation of the mobile terminal shown in FIG. 3 to save shown data.

### DETAILED DESCRIPTION OF THE INVENTION

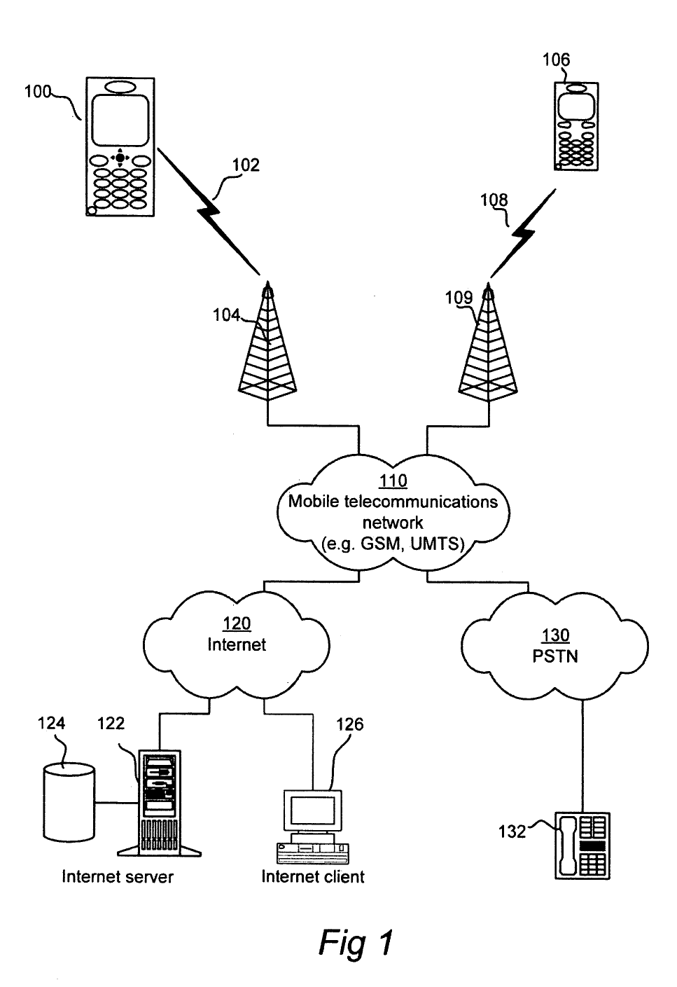

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

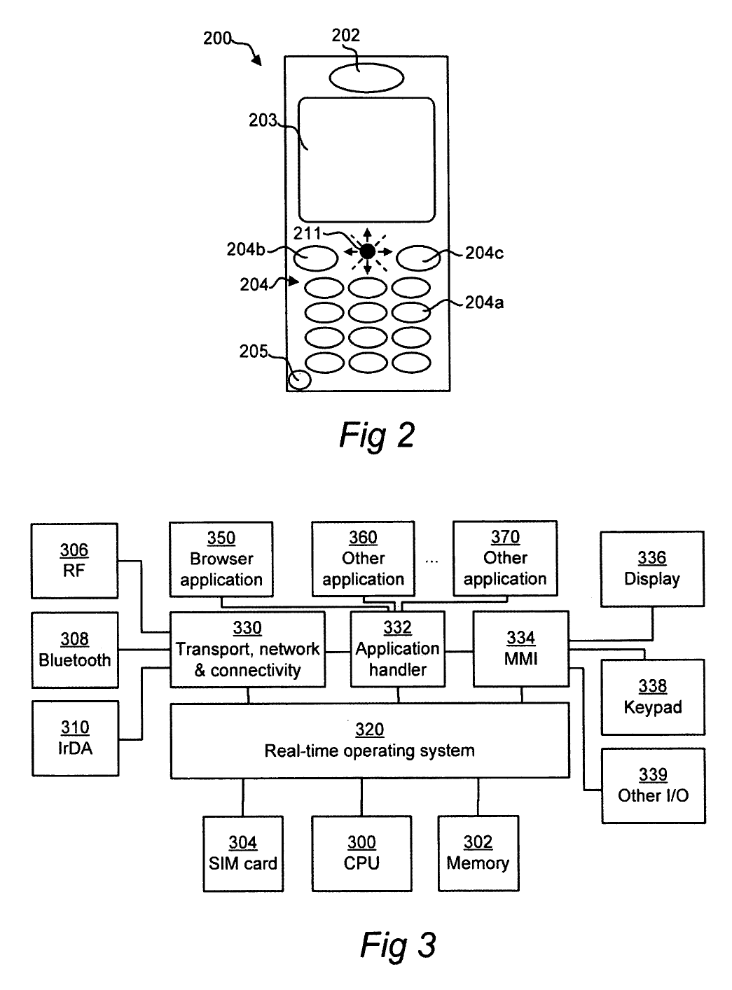

An embodiment 200 of the mobile terminal 100 is illustrated in more detail in FIG. 2. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications include a browser application 350, as well as various other applications 360 and 370, such as applications for voice calling, video calling, sending and receiving SMS, MMS or email, an instant messaging application, a phone book application, a calendar application, a control panel application, a camera application, a media player, one or more video games, a notepad application, etc.

The MMI 334 also includes one or more hardware controllers, which together with the MMI drivers cooperate with the display 336/203, keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

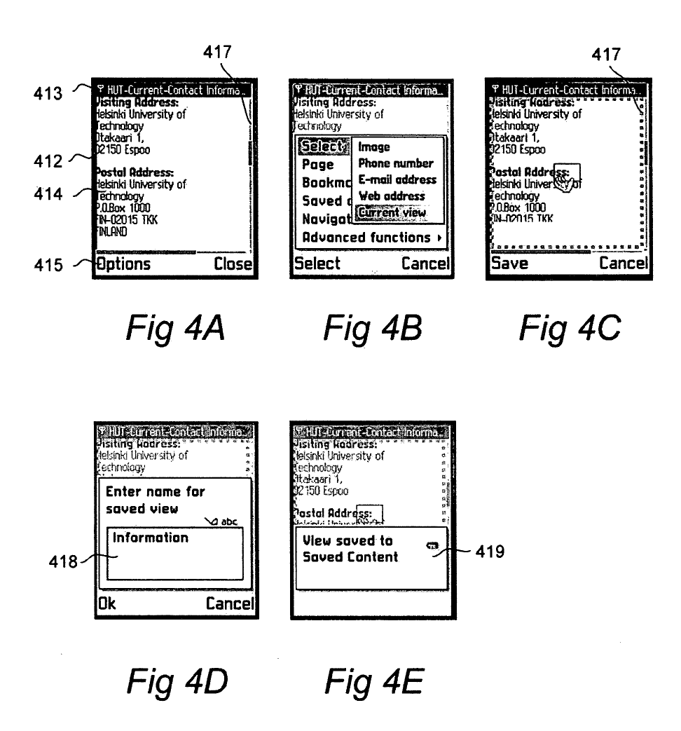

FIGS. 4A to 4E illustrate screenshots of a display of an embodiment of the present invention when saving current display data. A display view 412 comprises a status bar 413, a main display area 414 and a soft key bar 415. The status bar 413 typically includes information such as the current signal level and may include a title associated with the currently shown content. As is known in the art, the text in the soft key bar 415 may change when the function of a soft key changes depending of the current user context of a currently running application.

In FIG. 4A, a web browser is running in the mobile terminal, displaying the content web document on the main display area 414. As can be seen in a scroll bar 417 on the right side of the main display area 414, the content shown by the browser is not at the top of the document, but somewhere in the middle. The user may, for example, have scrolled down on the web document to view address information for an impending meeting. As will be shown here, the user may, using the present invention, at this point choose to save the current view for easy access at a later point in time.

FIG. 4B shows a screenshot when the user has navigated using a soft key, such as soft key 204b in FIG. 2, and a navigational input device, such as joystick 211 in FIG. 2, to select the current view.

FIG. 4C shows a screenshot when the user has selected the current view. The selection is in this embodiment indicated by a dashed line 417 around the main display area 414. The user then presses the left soft key 204b to save the data in the current view.

In FIG. 4D, the user may specify a name for the saved data. In this example, the name “information” is entered in the input box 418.

Once the name has been submitted, a confirmation message 419 is shown in FIG. 4E to inform the user that the currently displayed data has been saved.

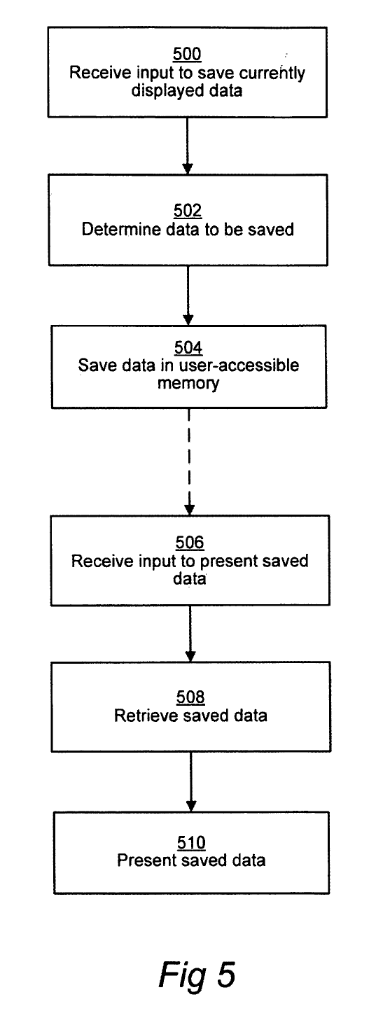

With reference to FIG. 5, the operation of the mobile terminal 200 for saving data currently shown on the display 203 will now be described. In FIG. 5, it is assumed that the user previously somehow has navigated and possibly scrolled to a document with desired information currently showing on the display 203 of the mobile terminal 200.

In step 500, a user input is detected, indicating that the user wishes to save the data currently shown on the display 203 of the mobile terminal 200. This input may be detecting the use of soft keys as discussed in conjunction with FIG. 4, or detecting any suitable way of triggering the currently shown data to be saved. For example, saving of the currently shown view may also be triggered using a dedicated key, a long press on a key normally used for other purposes, a voice command, etc.

In step 502, data to be saved is determined. In one embodiment, it is determined that the entire document should be saved. In this case data related to the scroll position, and optionally zoom level or other presentation parameters, is determined to be part of the data to be saved. This embodiment gives the user the advantage that he/she may scroll up or down from the position at the time the data was captured.

In another embodiment, it is determined that only data related to what is visible on the screen is to be saved. In this case, in this step a copy is made of the currently viewed document and any content items in the document that are not in the current view are removed. The amount of space required to save the currently viewed data is thereby reduced.

In yet another embodiment, it is determined that only an identifier, such as a URL, related to the currently viewed document is to be saved, along with data related to the scroll position, and optionally zoom level or other presentation parameters. This embodiment requires the least amount of space to save the current view. In effect, this embodiment saves an extended bookmark, containing the URL and additional parameters. This data can either be considered a multi-part parameter or a multiple parameters.

In step 504, the data is saved in memory, such as memory 302 in FIG. 3. Advantageously, to prevent data loss when the terminal is switched off or runs out of battery, the data is stored in non-volatile memory, such as EEPROM, flash or hard drive memory. Optionally, the user may be asked for a name to be associated with the current view. Unless the data to be saved is only a URL and positioning data, as in one of the embodiments described above, both text data being related to the markup language and binary data, such as images, sounds or video clips, is saved in the memory 302. To allow images to later be displayed properly, image references may need to be changed in the markup text to refer to the locally stored images. If the entire web document is determined to be saved in the previous step, positioning data is also saved in memory in this step. The data is stored in a user-accessible part of the memory, so that the user may retrieve the data when desired at a later point in time.

Time may then pass, as indicated by the dashed arrow between steps 504 and 506.

In step 506, a user input is detected, indicating that the user wishes to view the saved data. This input may for example be effected by navigating in a content browser and selecting the content item corresponding to the saved data.

In step 508, the saved data is then retrieved from the non-volatile user-accessible memory, where it was previously saved in step 504.

Finally, in step 510, the saved data is presented on the display to be viewed by the user. If the data is stored as a web document, the browser application is advantageously used to again render the data on the display.

It is to be noted that although the term web documents has been used herein to reference content being shown on the display to be saved, any type of content may be shown and saved in the present invention, including, but not limited to, hypertext markup language (HTML), wireless markup language (WML) and extensible markup language (XML).

The invention has mainly been described above with reference to a few embodiments. However, as is readily appreciated by a person skilled in the art, other embodiments than the ones disclosed above are equally possible within the scope of the invention, as defined by the appended patent claims.

1. A method for saving data shown on a display of a mobile terminal, comprising the steps of:
receiving an input indicating that currently shown data is to be saved;
determining save data, said save data comprising a part of a document shown on said display; and
saving said save data in a user-accessible memory.

2. The method according to claim 1, wherein said part of said document comprises data of said document shown on said display and data of said document located after data shown on said display.

3. The method as defined in claim 1, wherein said step of saving said data includes:
saving at least one parameter indicating a position of a currently shown view in said document.

4. The method as defined in claim 1, wherein said step of saving said save data involves:
saving a copy of said document; and
saving at least one parameter indicating a position of a currently shown view in said document.

5. The method as defined in claim 1, wherein said step of saving said save data involves:
saving a reference to a copy of said document, said copy being previously stored in said mobile terminal; and
saving at least one parameter indicating a position of a currently shown view in said document.

6. The method as defined in claim 1, wherein said document is an original document, and said step of saving said save data involves:
creating a modified document being a modification of said original document, such that content items of said original document currently visible on said display are copied to produce said modified document; and
saving said modified document in a user-accessible memory.

7. The method as defined in claim 1, wherein said document is rendered by a browser application.

8. The method as defined in claim 1, wherein said document complies with a markup language selected from a group consisting of hypertext markup language, wireless markup language and extensible markup language.

9. The method as defined in claim 1, wherein said save data includes text data and image data.

10. The method as defined in claim 1, wherein said user-accessible memory is a local non-volatile memory in said mobile terminal.

11. The method as defined in claim 1, comprising the further steps of:
receiving an input indicating that said saved data is to be presented;
retrieving said saved data from said user-accessible memory; and
presenting said saved data on said display.

12. A method for saving a reference to document currently rendered on a display of a mobile terminal by a browser application, comprising the steps of:
receiving an input indicating that a reference to currently shown data is to be saved;
saving, in a user-accessible memory, an identifier to said document and at least one parameter indicating a position of a currently shown view in said document.

13. A method for saving data shown on a display of a mobile terminal, said method comprising the steps of:
receiving an input indicating that currently shown data is to be saved;
saving an image copy of an entire document, at least part of said document currently being rendered on said display by a browser application; and
saving at least one parameter indicating a position of a currently shown view in said document.

14. The method as defined in claim 13, wherein said user-accessible memory is a local non-volatile memory in said mobile terminal.

15. A mobile terminal capable of saving data shown on a display of said mobile terminal, said mobile terminal comprising:
means for receiving an input indicating that currently shown data is to be saved;
means for determining save data, said save data comprising a part of a document shown on said display; and
means for saving said save data in a user-accessible memory.

16. The mobile terminal as defined in claim 15, wherein said data shown on said display is rendered by a browser application.

17. The mobile terminal as defined in claim 15, wherein said document complies with a markup language selected from a group consisting of hypertext markup language, wireless markup language and extensible markup language.

18. A computer program comprising software instructions that, when executed in a mobile communication terminal, performs the method according to claim 1.
